(19) United States
(12) Patent Application Publication
(10) Pub. No.: US 2005/0232842 A1
(43) Pub. Date: Oct. 20, 2005

(54) Method for the production of endohedral fullerenes

(76) Inventors: Lothar Dunsch, Dresden (DE); Petra Georgi, Dresden (DE); Frank Ziegs, Dresden (DE); Heidi Zoeller, Dresden (DE)

Correspondence Address: JORDAN AND HAMBURG LLP, 122 EAST 42ND STREET, SUITE 4000, NEW YORK, NY, 10168, US

(21) Appl. No.: 10/519,696

(22) PCT Filed: Jul. 21, 2003
(86) PCT No.: PCT/DE03/02501

§ 371 Date: Feb. 28, 2005

(30) Foreign Application Priority Data
Jul. 22, 2002 (DE) 102 33 566.4

(51) Int. Cl. C01B 39/00

(52) U.S. Cl. 423/445 B

(57) ABSTRACT

Method for synthesizing endohedral fullerenes it an arc reactor by burning off graphite electrodes, characterized in that the burning off is carried out in an atmosphere, which contains a reactive gas component, consisting of at least two elements, in an inert gas or inert gas mixture.

The invention relates to a method for synthesizing endohedral fullerenes in an arc reactor by burning off graphite electrodes. The inventive method ensures a very high yield of fullerenes. The fullerenes synthesized can be used, for example, as contrasting agents for medical examinations.

Methods of synthesizing endohedral fullerenes in an arc reactor by burning off modified graphite electrodes are already known.

In the case of one of these methods, graphite electrodes, which are modified with one or more metals, are burned off in an atmosphere of flowing helium containing a small amount of nitrogen in an arc reactor for the Krätschmer-Huffman method (U.S. Pat. No. 6,303,760 B1), endohedral metal fullerenes of the type A₃₋ₙXₙ@Cₘ being obtained. The yield of endohedral metal fullerenes, obtained by this method, is very small; it is said to be between 3 and 5% (Stevenson, S. et al., Small-bandgap endohedral metallofullerenes in high yield and purity, Nature 401, 55-57 (1991)).

It is an object of the invention to provide a method for synthesizing endohedral fullerenes in an arc reactor by burning off graphite electrodes, with which it is possible to increase the yield of fullerenes significantly.

This objective is accomplished with the method presented in the claims.

The inventive method is characterized in that the burning off is carried out in an atmosphere, which contains a reactive gas component, consisting of at least two elements, in an inert gas or mixture of inert gases.

The proportion of the reactive gas component may amount to 5% by volume up to 60% by volume. Preferably, it is 5% by volume up to 10% by volume.

According to an advantageous development of the method, a nitrogen-containing or carbon-containing reactive gas component, such as ammonia or methane or other hydrocarbons, is used.

The reactive gas component may be supplied to the arc reactor during the burning off or generated in the arc reactor.

Graphite electrodes, which are modified with metal or metal oxides, can be used for the inventive method.

Accordingly, graphite electrodes may be used, which are modified, for example, with holmium or scandium or their oxides.

According to an advantageous development of the inventive method, graphite electrodes, which have been modified with metal or metal oxides and a nitrogen-containing substance, can also be used.

Especially a metal cyanamide, preferably calcium cyanamide or lead cyanamide, can be used to modify the graphite electrodes with a nitrogen-containing substance.

With the inventive method, a very high yield of fullerenes of 50 to 95% of endohedral M₃N cluster fullerenes as main product is attained. The cost of carrying out the method is low and the method can be carried out easily and leads to reproducible results.

The fullerenes, synthesized in this way, may be used, for example, as contrasting agents for medicinal investigations.

The invention is explained in greater detail below by means of examples.

### EXAMPLE 1

In an arc reactor, holmium metal-modified graphite electrodes are burned off with a pulsed DC current with a current strength between 75 A and 150 A in a gas mixture, which contains a reactive gas component. The graphite electrodes used have a composition, in which the molar ratio of graphite to holmium is 1:0.4. The gas mixture consists of helium and ammonia, the ammonia being the reactive component. The proportions in the gas mixture are 200 mbar of helium and 20 mbar of ammonia.

When this method is carried out, endohedral holmium nitride cluster fullerenes are formed in a yield between 85 and 95%.

### EXAMPLE 2

Ho₂O₃-modified graphite electrodes are burned off in an arc reactor in a gas mixture, which contains a reactive gas component, with pulsed DC with a current density of between 75 A and 150 A. The graphite electrodes used have a composition, in which the molar ratio of graphite to M₂O₃ is 1:0.3. The gas mixture consists helium and ammonia, the ammonia being the reactive component. The proportions in the gas mixture are 200 mbar of helium and 20 mbar of ammonia.

When this method is carried out, endohedral holmium nitride cluster fullerenes are formed in a yield of 60%

### EXAMPLE 3

Scandium- and CaNCN-modified graphite electrodes are burned off in an arc reactor in a gas mixture, which contains a reactive gas component, with pulsed DC with a current density of between 75 A and 150 A. The graphite electrodes used have a composition, in which the molar ratio of graphite to scandium to CaNCN is 1:0.6:0.4. The gas mixture consists of helium and ammonia, the ammonia being the reactive component. The proportions in the gas mixture are 200 mbar of helium and 10 mbar of ammonia.

When this method is carried out, endohedral holmium nitride cluster fullerenes are formed in a yield between 80 and 90%.

### EXAMPLE 4

Graphite electrodes modified with Ho₂O₃ and CaNCN, are burned off in an arc reactor in a gas mixture, which contains a reactive gas component, with pulsed DC with a current density of between 75 A and 150 A. The graphite electrodes used have a composition, in which the molar ratio of graphite to Ho₂O₃ to CaNCN is 1:0.4:0.4. The gas mixture consists of helium and ammonia, the ammonia being the reactive component. The proportions in the gas mixture are 200 mbar of helium and 10 mbar of ammonia.

When this method is carried out, endohedral holmium nitride cluster fullerenes are formed in a yield between 50 and 70%

### EXAMPLE 5

Graphite electrodes are burned off in an arc reactor in a gas mixture, which contains a reactive gas component, with pulsed DC with a current density of 150 A. The gas mixture consists of helium and methane, the methane being the reactive component. The proportions in the gas mixture are 200 mbar of helium and 10 mbar of methane.

When this method is carried out, CH₂@C₇₀ is obtained as main component of the endohedral fullerenes, C₆₀ and C₇₀ representing the main propulsion of the total fullerene content.

1. Method for synthesizing endohedral fullerenes it an arc reactor comprising burning off graphite electrodes, in an atmosphere which contains a reactive gas component, and providing said reactive gas component with at least two elements in an inert gas or inert gas mixture.

2. The method of claim 1, wherein the inert gas or the inert gas mixture includes 5% by volume to 60% by volume of reactive gas component.

3. The method of claim 1, wherein the inert gas or the inert gas mixture includes 5% by volume to 10% by volume of reactive gas component.

4. The method of claim 1, wherein the inert gas or inert gas mixture includes a nitrogen-containing or carbon-containing reactive gas component.

5. The method of claim 1, wherein the reactive gas component includes of ammonia or methane or of other hydrocarbons.

6. The method of claim 1, wherein the reactive gas component is supplied to the arc reactor from outside during the burning off or is generated in the arc reactor.

7. The method of claim 1, wherein graphite electrodes are used which are modified with metal or metal oxides.

8. The method of claim 7, wherein the graphite electrodes which are used are modified with holmium or scandium or their oxides.

9. The method of claim 1, wherein the graphite electrodes which are used are modified with metal or metal oxides and a nitrogen-containing substance.

10. The method of claim 1, wherein the graphite electrodes which are used are modified with metal cyanamide.

11. The method of claim 1, wherein the graphite electrodes which are used are modified with calcium cyanamide or lead cyanamide.
